(19) United States
(12) Patent Application Publication
(10) Pub. No.: US 2008/0009339 A1
(43) Pub. Date: Jan. 10, 2008

(54) Gaming Table And Method For Use Thereof With Gaming Chips Incorporating An Electronic Microchip

(76) Inventors: Butrico Pat, Las Vegas, NV (US); Laurent Gaubout, Las Vegas, NV (US); Emmanuel Gelinotte, Les Beaune (FR); Gerard Charlier, Paris (FR); Guillermo Bernal, Las Vegas, NV (US)

Correspondence Address: HERSHKOVITZ & ASSOCIATES, 2845 DUKE STREET, ALEXANDRIA, VA, 22314, US

(21) Appl. No.: 10/590,150

(22) PCT Filed: Jul. 10, 2006
(86) PCT No.: PCT/FR06/01678

§ 371 Date: Apr. 2, 2007

(51) Int. Cl. G06F 17/00

(52) U.S. Cl. 463/25

(57) ABSTRACT

A gaming table, for use with electronic memory microchip gaming chips, includes a tabletop including a gaming chip storage rack and a test station including a communication unit adapted to exchange information with the memory of a gaming chip in a test area by way of an antenna device, the communication unit being associated with a digital processing unit delivering an output message to the screen of a display device. The layout of the table is such that the screen of the display device is physically separate from the casing of the test station and the test area and the screen are disposed close together on the tabletop, beside the rack and in reach and in view of the operator. The gaming table is usable in casinos and gaming rooms.

The present invention relates to a gaming table for use with gaming chips incorporating an electronic memory microchip used in casinos and gaming rooms. The invention is particularly beneficial for gaming tables, including blackjack, baccarat, minibaccarat and stud poker gaming tables and tables for games derived from those games, but can also be used with benefit on cash tables or change tables.

The expression “gaming chip” or “casino chip” means any disk or plate representing a value, possibly a nominal value. Chips are generally fabricated from scratch-resistant rigid plastics material. Chips feature varied patterns in terms of design and color to form a more or less complex decoration and to reduce the risk of fraudulent reproduction and/or falsification.

To facilitate the management and tracing of chips, and to reduce further the risk of fraud, certain chips carry coded information by incorporating in the body of the chip an electronic circuit including a memory for storing information concerning the chip, in particular a number or an identifier and its numerical value. Chips equipped with an electronic circuit including a memory are known as “electronic memory chips”, “electronic microchip chips” or “electronic circuit chips”. Different designs of chips have electronic circuits including PROM, EEPROM, or even microprocessors with associated memory.

Chips are often stored in trays or racks that conventionally serve as local reserves of chips at the money changing tables and/or gaming tables. A rack contains chips exchanged for cash, for example, or for chips of different face value, etc. It is also possible to take from a rack the chips necessary to pay out winning plays and to place in a rack chips of losing plays. The rack must be continuously monitored by the table operator, in this instance the croupier, of course.

With the aim of fighting fraud and/or errors in counting or handling electronic microchip chips, European patent EP 0740818 in the name of the Applicant proposes equipping cash, change and gaming tables with a gaming chip test station for testing the authenticity and/or the value of the electronic microchip chips. The casing of this RFID (radio-frequency identification) test station contains a communication unit adapted to exchange information in read-only mode or in read/write mode with the memory of a chip placed in a test area on the tabletop under which is disposed an antenna device connected to the communication unit, a unit for processing information contained in said memory, and a device for displaying an output message obtained at least in part from information contained in said memory, said display device including a screen disposed on the top of the test station casing. To enable the table operator, usually a croupier or a controller, to view the display screen, in the arrangement described in European patent EP 0740818 the casing of the test station is placed in the tabletop under a small window in the tabletop.

This arrangement has not proved convenient for relatively small gaming tables, for example blackjack tables, where the tabletop is somewhat congested, in particular by the chip rack, the antenna(s) of the chip test areas, the tip box, etc. Disposing the casing with its display screen below the tabletop and projecting a little way on the operator side is not really satisfactory in that the casing may impede the movement of the croupier and the position of the screen obliges the croupier to move his eyes away from the playing area on the table, which diverts his attention from the playing area, which is not recommended from the point of view of the security and surveillance of the table, the rack and the players.

There is therefore a need for a gaming table for use with gaming chips with an electronic memory circuit equipped with an RFID test station for verifying the authenticity of gaming chips, counting gaming chips and/or determining the value of gaming chips that offers improved ergonomics for the operator and in particular enables the display screen to be viewed in the same field of view as the tabletop.

To this end, the invention proposes a gaming table for use with electronic memory microchip gaming chips, comprising:
a tabletop including a gaming chip storage area and at least one gaming chip testing area,
at least one test station including a communication unit adapted to exchange information with the memory of a gaming chip in said test area by means of an antenna device on and/or in said tabletop, the communication unit being associated with a processing unit for processing information contained in said memory, and
at least one display device for displaying an output message obtained from the processing unit and based at least in part on information contained in said memory, said display device including a screen on and/or in said tabletop,

wherein the display device is physically separate from the casing of said test station and the chip test area and the screen of the display device are close together, beside said storage area and in reach and in view of the operator of the table.

Thanks to the new arrangement in accordance with the invention, it is possible to dispose the chip test area (and its antenna) beside the chip storage area, in this instance the chip rack, and to dispose the display screen on the tabletop, also beside the chip rack, with everything within reach and within sight of the table operator (croupier), and to offer improved ergonomics in a very secure gaming table for use with gaming chips with electronic microchips.

In a first embodiment of the invention, the screen of the display device is a flat screen mounted flush with the tabletop.

In another embodiment in which the gaming table for use with gaming chips incorporating an electronic microchip is of the type in which the tabletop has a rectangular or pseudo-rectangular shape with two longer sides, namely a proximal operator side carrying said storage area, which is also of rectangular or pseudo-rectangular shape, and a distal customer side, the chip test area is in the vicinity of a shorter side of said storage area.

The test area and the screen of the display device are advantageously substantially on respective opposite sides of a (customer side) distal corner of the storage area.

In another embodiment of the invention, the screen of the display device has a single display line parallel to the proximal longer side of the tabletop. This facilitates placing the screen on the tabletop combined with fast testing of the authenticity of the gaming chips by displaying the total value read from the gaming chips in the test area for comparison with the value calculated mentally by the croupier, there usually being a relatively small number of gaming chips in the test area simultaneously, for example 10 to 20 chips.

In a further embodiment of the invention, the communication unit is wholly or partially under the tabletop of the table and said test station also incorporates in its casing the information processing unit, which has an output connected to the display device.

In a further embodiment of the invention, the gaming table is of the type in which the chip storage area is a chip rack. The chip test area is advantageously beside a tip box. The screen is advantageously immediately in front of the chip rack on the customer side.

In a further embodiment of the invention the table includes two chip test areas disposed laterally on either side of the chip rack and combined either with a screen that is centrally located with respect to the rack or with two lateral screens.

The screen or the screens is or are advantageously immediately in front of the chip rack on the customer side.

In a further embodiment of the invention, the tabletop of the table includes other areas for electronically reading or reading/writing gaming chips associated with antennas having appropriate multiplex connections to the test station and via said test station to the screen of the display device. The electronic reading or reading/Writing areas advantageously consist of the gaming stations of the table, on which the players place their bets.

The invention is applicable to gaming tables including blackjack, baccarat, minibaccarat and stud poker gaming tables and to gaming tables for games derived from those games. The invention also applies to cash tables and change tables.

The invention also relates to gaming room surveillance equipment including at least one gaming table as defined above and at least one display duplicator device associated with said display device and including a second screen external to the gaming table that can be viewed by a second gaming room or casino operator.

In a first embodiment of the surveillance equipment the display duplicator device is near the location of a table chief or a table supervisor.

In another embodiment the display duplicator device is integrated into the video surveillance system of the gaming room by means of a serial external interface, an IP network or an analogous network, with embedded display on screens of video monitors of gaming room or casino surveillance or security staff.

Other objects, features and advantages of the present invention will become apparent on reading the following description of one preferred embodiment of the invention given by way of nonlimiting example with reference to the appended drawings, in which:

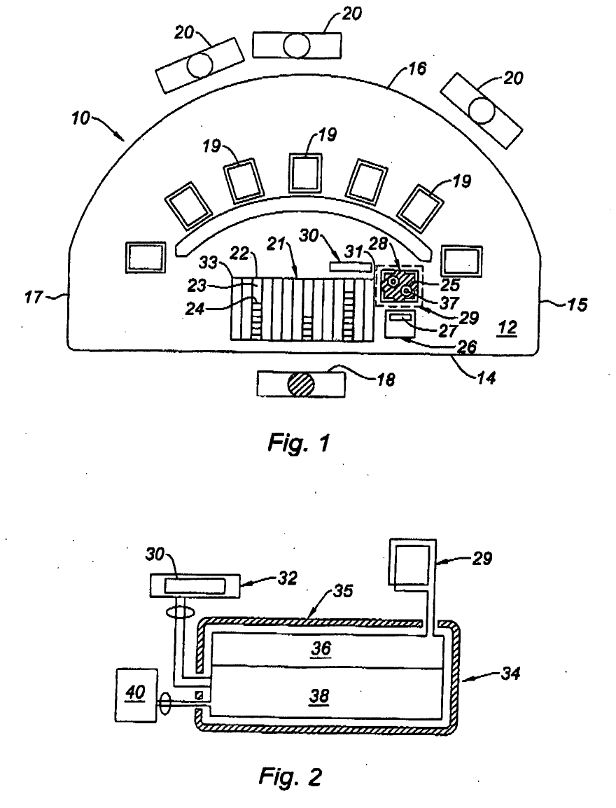

FIG. 1 is a diagrammatic plan view of a gaming table for use with electronic microchip gaming chips conforming to a first embodiment of the invention;

FIG. 2 is a diagram of a test station for electronic microchip gaming chips associated with the table shown in FIG. 1;

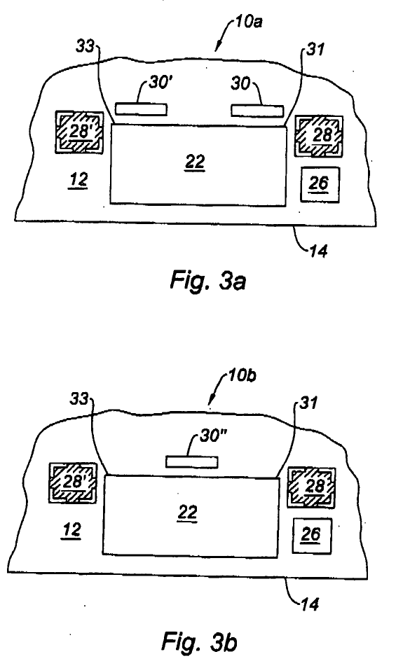

FIGS. 3a and 3b are diagrammatic top views of the tabletops of two embodiments of gaming tables in accordance with the invention each having two chip test areas;

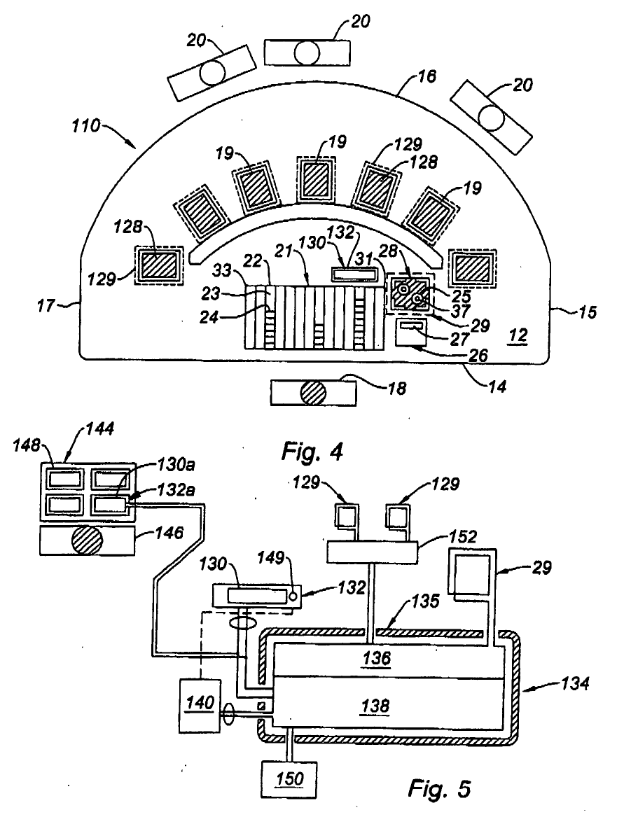

FIG. 4 is a diagrammatic top view of a second embodiment of a gaming table for use with electronic microchip gaming chips of the invention; and

FIG. 5 is a diagram of a test station for electronic microchip gaming chips associated with the table shown in FIG. 4.

In the figures, which are not limiting on the invention, the various items are not necessarily represented to scale. Identical reference numbers are used in the various figures to designate identical or similar items. Dimensions are indicated by way of example only.

A gaming table 10 according to the invention shown from above in FIG. 1 by way of nonlimiting example is a blackjack table of which only the tabletop 12 can be seen. The tabletop 12 has a pseudo-rectangular shape with two longer sides 14 and 16 and two shorter sides 15 and 17. The first longer side 14 called the operator side or proximal side has a substantially rectilinear edge in front of which stands the casino operator, generally a croupier 18 represented diagrammatically in FIG. 1, facing a storage area 21 for gaming chips, consisting in this instance of a chip rack 22. The other longer side 16 called the customer side or distal side has a curved convex edge in front of which customers stand, in this instance three players 20 shown in front of their respective gaming stations 19. The tabletop 12 is generally covered with a mat of felt, wool or synthetic material on which is printed, as can be seen in FIG. 1, a decoration including seven gaming stations 19 on which the players place their bets, each shown by a rectangle. Without departing from the scope of the invention, some blackjack tables have six or nine gaming stations (also known as ‘spots’ or ‘betting positions’) whereas baccarat tables have up to 12 or 14 gaming stations. The tabletop 12 carries the generally removable rectangular chip rack 22 in the middle of the edge 14, the rack having a capacity from 100 to 200 chips divided between around fifteen U-section housings or troughs 23 that receive horizontal columns of chips 24 standing on edge. In a manner that is conventional in the case of blackjack tables, the tabletop 12 carries to the right of the chip rack 22 relative to the croupier 18 a tip box 26 integrated Into the tabletop and having a slot 27 into which the croupier can insert tips in the form of gaming chips.

To complete the description of the tabletop 12, the latter has a reading area 28 (shown cross-hatched in FIG. 1 and delimited by a corner marker with four corners) on which two gaming chips 25 are placed, for example. The test area 28, bordered by an antenna 29 represented in dashed outline, is disposed beside the tip box 26, near the right-hand distal corner 31 of the rack 22. The tabletop 12 includes the screen 30 of a display device 32 (shown in FIG. 2) disposed parallel to the edge 14 of the tabletop along the rack 22 close to the apex of the corner 31, flush with the tabletop and optionally protected by a window or a sheet of transparent plastic material. The screen 30 is of any type known in the art, in particular the light-emitting diode (LED) type or the liquid crystal display (LCD) type with backlighting or a reflective mirror, and here, by way of nonlimiting example, takes the form of a one-line display strip to ensure good legibility for the croupier at the same time as minimizing the space taken up by the screen on the tabletop.

FIG. 2 is a diagram of the test station 34 used with the gaming table of the invention. The station 34 has an analogue part 36 defining a communication unit for exchanging information with the electronic microchips 37 of the gaming chips 25 in the test area 28 and a digital part 38 defining a microprocessor-based digital processing unit. Again by way of nonlimiting example, the two sections take the form of two electronic circuit cards disposed in a common casing 35 fixed to the table 10 under the tabletop 12 or to the base (not shown) of the table 10. Of course, the processing unit 38 may, without departing from the scope of the invention, be entirely or partly outside the casing 35 and integrated into or associated by an appropriate network with a central server, possibly equipped with a database concerning the batches of chips in use and the gaming tables that are active in the gaming room or casino, and adapted to manage or to serve a plurality of tables according to the invention.

The test station 34 includes the antenna device 29 covering the test area 28 and appropriately connected to the communication unit 36. Without departing from the scope of the invention, the gaming table of the invention may include analogous or alternative devices under the tabletop 12 to cover other test areas on the tabletop 12 (see for example the tabletops with two test areas shown in FIGS. 3a and 3b), either from the same test station 34 using a series connection of the antennas or a parallel connection combined with an antenna selection or multiplexing interface (not shown), or from separate other test stations, preferably with synchronized transmission/reception. Moreover, it is equally possible to use with the gaming table of the invention, instead of the basic chip rack 22, an electronic chip rack (not shown) equipped with a station for reading or reading/writing the memory of the chips in various columns of the rack, for example an electronic rack of the type described in European patent EP 1 461 783 in the name of the Applicant. This example is not limiting on the invention.

The test station 34 is conventionally of the read/write type 34 able to read and write the memory of the gaming chips. Without departing from the scope of the invention, a simplified version of the test station could include only means for reading the memory of the gaming chips, its structure and operation being similar to what is described hereinafter for the read/write test station 34.

The invention uses improved gaming chips and/or plates including a “contactless” type electronic identification device. More precisely, each chip 25 includes an electronic circuit 37 whose memory contains coded information specific to the chip to enable it to be identified and authenticated with the aid of an appropriate reader unit (a read-only unit or a read/write unit operating in read mode). In the simplest version, the electronic circuits (not shown) of the chips are of the microcircuit type with a non-reprogrammable memory (for example of PROM type) and having a unique identification code of 32 or 84 bits generally including the serial number of the chip or of the batch of chips (its face value and other information concerning the chip such as the name of the casino, etc. may be stored in a database external to the chips with access thereto on the basis of the serial number of the chip or the batch number). Regardless of the type of memory used in the gaming chip, its electronic identification circuit 37 further includes a transmitter/receiver with a circular peripheral loop antenna also incorporated into the chip and adapted to be supplied with power by inductive coupling from the exterior antenna of the read or read/write station (in this instance the antenna 29 of the read/write test station 34 installed in the tabletop 12 under the test area 28).

In a more sophisticated version, the gaming chips have a code that can be changed and are equipped with reprogrammable memory (for example of EEPROM type) that can be read and written. This possibility of modifying the information contained in the memory increases the level of security of the electronic gaming chip, in particular by enabling the authentication parameters to be changed over time. Similarly, it is possible to personalize certain areas of the memory and then to configure them reversibly or otherwise as a defined memory area with read-only access or with read/write access (the information concerning the chip stored in the memory thereof in this way may include, by way of nonlimiting example, in addition to the serial number of the chip or the batch, the face value of the chip, the name of the casino, the chip fabrication number and date, etc.). In an optional and even more sophisticated version, the gaming chip is equipped with a microprocessor able to perform complex processing and transactions, for example monitoring the dialogue between the electronic read station or read/write station and the chip, whereby dialogue is authorized after mutual authentication, with the entry of password type codes and/or cryptography keys into the chip and the electronic unit (in particular to encrypt data during transfer thereof between the electronic unit and the chip).

Moreover, the electronic circuit 37 of the gaming chips 25 is adapted to simultaneously read and/or write a plurality of chips or to discriminate between the chips so that it can process stacked gaming chips or plates. In the embodiment of the invention described by way of nonlimiting example, the test station integrating the discrimination function is adapted to capture the identity of a first gaming chip in a batch of chips 25 situated in the field of the antenna 29, for example a stack of chips placed in the test area 28. It is then possible to dialogue with this first chip and to perform the required reading and/or writing operations, after which the chip is deactivated by sending it a command to go to a standby mode. The test station 34 continues its search for other chips in the working area of the antenna 29 and captures all the chips successively. After the capture and/or processing of the last chip, the dialogue unit sends a command to reactivate all the chips that have been deactivated at the end of dialogue or transaction. This chip discrimination function is also referred to as an anti-collision function.

The structure and the method of fabricating the gaming chips including an electronic memory circuit is not described in detail here. By way of nonlimiting example, the application EP-A-0694872 in the name of the applicant describes several types of chip and plate structures usable in the context of the present invention.

Considering FIG. 2 again, the wide loop type antenna 29 has an active area (for example 10×10 cm) adapted substantially to cover the test area 28, which occupies at least several times the face area of a chip 24, whose diameter is substantially from 40 to 60 mm and includes one or more turns of copper wire with a diameter of approximately 0.5 mm.

The “contactless” RFID type read/write test station 34 consists of the analogue part 3B and the digital processing part 38: the digital part 38 comprises a microcontroller that generates, interprets and processes signals exchanged with the electronic memory gaming chips. The digital processing section or unit 38 also controls an interface, for example an interface of the multiplexing type, for sequentially selecting antenna(s) for reading gaming chips (not shown) when the station 34 is used with more than one antenna. It also includes an oscillator that generates the carrier frequency (for example 126 kHz) of the radio-frequency signal fed to the antennas, a time and date circuit for timing and dating each event, PROM for storing the processing sequences of the microcontroller, EEPROM for storing the processed data and exchanging data with the electronic gaming chips, and an RS2321485 type serial interface for a point-to-point or network connection with a server computer (not shown). In particular, the digital part can operate in read-only mode or in read/write mode to read and/or store and/or test gaming chips in the test area 28 and to determine or check their total value.

The digital part 38 is additionally connected to the display device 32 and optionally connected to input peripherals (for example a keypad or numeric pad 40) and/or other output peripherals (for example a printer and/or an audible warning device, not shown). The keypad or numeric pad 40 is used to enter into the system information on the identity of the table concerned, for example to give the identity of the rack 22 in the case of removable racks, the initial or final content of the batch of gaming chips in the rack and/or the identity of the table operator. Moreover, the printer can print out some or all of the information appropriate to the chips tested.

The analogue part 36 contains an analogue/digital converter (ADC), a modulator and an amplifier. On the basis of signals, commands and information coming from the digital part 38, it generates an amplitude-modulated radio-frequency analogue signal which conveys power, data and a synchronization signal to the electronic memory gaming chips via the selected antenna. The electronic gaming chips 25 are of the passive (i.e. with no internal energy store) read-only or read/write type. Thus the antenna 29 has to supply the power necessary for the operation of the electronic circuit of the gaming chip and to transmit data. The working distance between the antenna 29 (which is a antenna loop integrated flat into the tabletop 12 and parallel thereto) and the gaming chips is defined as a function of the magnetic flux necessary for correct operation of the electronic circuit of the chip and therefore depends on the inductance and geometry of the antenna and the antenna current. The faces of the gaming chips 25 incorporating the coils of the electronic circuits 36 are preferably parallel to the loop of the antenna 29.

The improved ergonomics of the gaming table according to the invention described above should be noted. The croupier can test the chips 25 before stowing them with a single motion of the hand and without looking away from the playing area.

The invention is not limited to the gaming table described above: it is applicable in particular to gaming tables other than blackjack tables provided that the layout of the tabletop, the position of the equipment and the graphics on the corresponding gaming mat lend themselves to this, as well as to change and cash tables. Nor is the invention limited to a storage area defined by a gaming chip rack with horizontal columns, also covering other storage area variants used in casinos, including those in which the chips are stacked vertically.

In a variant of the invention that is not shown, the antenna 28 and the screen 30 are disposed on respective opposite sides of the left-hand distal corner 33 of the rack 22 in a symmetrical manner to FIG. 1.

In two further variants of gaming tables according to the invention shown partially in FIGS. 3a and 3b, each table 10a and 10b differs from the table shown in FIG. 1 and described above in that it includes two chip test areas 28, 28′ with two antennas (analogous to the antenna 29) connected in series or in parallel and associated with the same test station, of the same type as the test station 34 (with an appropriate interface in the case of a parallel connection), the test areas 28 and 28′ being disposed symmetrically with respect to the chip rack 22 and near each of its shorter sides, with either two display devices (identical or virtually identical to the device 32) with their screens 30 and 30′ each disposed near the corners 31 and 33 of the rack (as in the table 10a shown in FIG. 3a) or a single display device whose screen 30″ is centered on the longer side of the rack joining the corners 31 and 33 (as in the table 10b shown in FIG. 3b), the length of the rack being compatible with easy reading of the display screen by the croupier. These variants with two test areas speed up testing of chips by croupiers, who often work with both hands to save time.

FIGS. 4 and 5 show, again by way of nonlimiting example, a blackjack gaming table 110 conforming to a second embodiment of the invention and very similar to the table 10, with a test station 134 very similar to the test station 34 having a modified analogue part 136 and a modified digital part 138. Unless otherwise indicated, the above description with reference to FIGS. 1 and 2 applies equally to the devices shown in FIGS. 4 and 5, components of which that are identical or virtually identical to the components described above retaining the same reference numbers. Components analogous to components already described have the reference numbers of the latter components increased by 100.

Compared to the gaming table 10, the table 110 has further areas for electronically reading or reading/writing chips 128 covering the gaming stations (‘spots’) 19 of the table where players place their bets. The corresponding antennas 129 are disposed on or in the tabletop 12 to cover the areas 128 and are connected to the test station 134 by a multiplexing circuit 152 arranged, by way of nonlimiting example, external to the casing 135 of the station 134. Moreover, by way of nonlimiting example, the display 132 includes a screen 130 with two display lines, one for information coming from the test area 28 (antenna 29) and the other for information coming from one of the gaming stations or ‘spots’ 19 and indicating the serial number identifying the ‘spot’ display. The display optionally includes on (or more) key(s) 149 (shown only in FIG. 5) connected to the keypad 140 and used to select the ‘spot’ to be displayed. Of course, the invention is not limited to the embodiment described here and covers other analogous or derived arrangements in terms of the function and placement of the reading areas 128 on the table, the number of antennas 29 and 129 and their connections to the station 134 (the antenna 29 may also be connected to the multiplexing circuit 152), the number of ‘spots’ displayed simultaneously, the number of display lines on the screen 130 and the means for selecting the ‘spot or ’ spots' displayed. The table 110 may additionally be modified and incorporate one or the other of the table variants of the type described in relation to the tables 10a and 10b.

The invention also relates to a gaming room or casino surveillance equipment associated with either of the embodiments of a gaming table of the invention as described above (table 10 or table 110) adapted to duplicate some or all of the information displayed on the screen 30 (or 130) at another location in the gaming room or casino, to be viewed there by an operator other than the croupier 18 at the gaming table. In various embodiments, the other operator may be the table chief 146, who generally monitors four gaming tables from his desk (direct duplication) and/or the casino's security staff at a video surveillance station (integration into video surveillance).

By way of nonlimiting example, FIG. 5 shows a test station 134, modified to incorporate this additional double function. More particularly, the reference number 144 designates the desk of the table chief 146 including a display duplicator device 132a whose screen 130a duplicates the screen 130 and is identical or virtually identical to it and connected in parallel with it. The desk 144 includes three other duplicated devices 148 connected to test stations (not shown) associated with three other gaming tables (not shown) according to the invention that are identical or analogous to the table 110. The test station 134 further includes an output with an external serial interface 150 or IP network interface or the like connected to a video surveillance station (not shown) the video monitors whereof receive a display signal in which the information displayed on the screen 130 is embedded.

Of course, the invention is not limited to the surveillance equipment embodiment described here and encompasses other analogous or derived arrangements employing either the direct duplication function or the video surveillance integration function. Moreover, the invention is not limited to the type of gaming table 110 having additional reading or reading/writing areas 128 associated with the gaming stations 19, also encompassing surveillance equipment for gaming tables of the types described with reference to the tables 10, 10a and 10b (with corresponding modifications to the table and the test station analogous to those described in relation to the table 110).

1-32. (canceled)

33. A gaming table for use with electronic memory microchip gaming chips, comprising:
a tabletop including a gaming chip storage area and at least one gaming chip testing area;
at least one test station including a communication unit adapted to exchange information with a memory of a gaming chip in said gaming chip testing area by an antenna device disposed at least one of on and in said tabletop, the communication unit being associated with a processing unit for processing information contained in said memory; and
at least one display device for displaying an output message obtained from the processing unit and based at least in part on information contained in said memory, said display device including a screen at least one of on and in said tabletop,
wherein the display device is physically separate from a casing of said test station and the gaming chip testing area and the screen of the display device are close together, beside said storage area and in reach and in view of an operator of the table.

34. The gaming table according to claim 33, wherein the screen of the display device is a flat screen mounted flush with the tabletop.

35. The gaming table according to claim 33, wherein the tabletop has one of a rectangular or pseudo-rectangular shape with two longer sides, wherein said tabletop comprises a proximal operator side carrying said storage area, which is also one of a rectangular or a pseudo-rectangular shape, and a distal customer side, and wherein the gaming chip testing area is in the vicinity of a shorter side of said storage area.

36. The gaming table according to claim 35, wherein the gaming chip testing area and the screen of the display device are substantially on respective opposite sides of a substantially distal corner of the storage area.

37. The gaming table according to claim 35, wherein the screen of the display device has a single display line parallel to the proximal operator side of the tabletop.

38. The gaming table according to claim 33, wherein the communication unit is one of wholly or partially under the tabletop of the gaming table and said test station also incorporates in its casing the processing unit which has an output connected to the display device.

39. The gaming table according to claim 33, wherein the chip storage area is a chip rack.

40. The gaming table according to claim 39, wherein the gaming chip testing area is located beside a tip box.

41. The gaming table according to claim 39, wherein two gaming chip testing areas are disposed laterally on either side of the chip rack and are combined with one of, a screen that is centrally located with respect to the chip rack, or with two lateral screens.

42. The gaming table according to claim 41, wherein said one of the screen or two lateral screens is/are placed immediately in front of the chip rack on a customer side of the gaming table.

43. The gaming table according to claim 33, further comprising, on the tabletop of the gaming table, other areas for one of a) electronically reading or b) electronically reading and writing gaming chips associated with antennas having appropriate multiplex connections to the test station and via said test station to the screen of the display device.

44. The gaming table according to claim 43, wherein one of the a) electronically reading or b) electronically reading and writing areas comprise gaming stations of the gaming table.

45. The gaming table according to claim 33, wherein the gaming table comprises one of a blackjack, baccarat, minibaccarat or stud poker gaming table, a gaming table for games derived from the above games, a cash table or a change table.

46. A gaming table for use with electronic memory microchip gaming chips, comprising:
a tabletop including a gaming chip storage area and at least one gaming chip testing area;
at least one test station including a communication unit adapted to exchange information with a memory of a gaming chip in said gaming chip testing area by an antenna device disposed at least one of on and in said tabletop, the communication unit being associated with a processing unit for processing information contained in said memory;
at least one display device for displaying an output message obtained from the processing unit and based at least in part on information contained in said memory, said display device including a screen at least one of on and in said tabletop; and
on the tabletop of the gaming table, other areas for one of a) electronically reading or b) electronically reading and writing gaming chips associated with antennas having appropriate multiplex connections to the test station and via said test station to the screen of the display device,
wherein the display device is physically separate from a casing of said test station and the gaming chip testing area and the screen of the display device are close together, beside said storage area and in reach and in view of an operator of the table;
the screen of the display device is a flat screen mounted flush with the tabletop;
the tabletop has one of a rectangular or pseudo-rectangular shape with two longer sides, wherein said tabletop comprises a proximal operator side carrying said storage area, which is also one of a rectangular or a pseudo-rectangular shape, and a distal customer side, and wherein the gaming chip testing area is in the vicinity of a shorter side of said storage area;
the gaming chip testing area and the screen of the display device are substantially on respective opposite sides of a substantially distal corner of the storage area;
the screen of the display device has a single display line parallel to the proximal operator side of the tabletop;
the communication unit is one of wholly or partially under the tabletop of the gaming table and said test station also incorporates in its casing the processing unit which has an output connected to the display device;
two gaming chip testing areas are disposed laterally on either side of the chip rack and are combined with one of, a screen that is centrally located with respect to the chip rack, or with two lateral screens; and
said one of the screen or two lateral screens is/are placed immediately in front of the chip rack on a customer side of the gaming table.

47. A gaming room surveillance equipment comprising at least one gaming table according to claim 33, wherein at least one display duplicator device is associated with said display device of said gaming table and a second screen external to the gaming table can be viewed by a second gaming room operator.

48. The gaming room surveillance equipment according to claim 47, wherein the display duplicator device is near the location of said second gaming room operator who is one of a table chief or a table supervisor.

49. The gaming room surveillance equipment according to claim 47, wherein the display duplicator device is integrated into a video surveillance system of a gaming room by one of a serial external interface, an IP network or an analogous network, with embedded display on screens of video monitors of one of a gaming room surveillance or a security staff.

50. The gaming table according to claim 46, wherein one of the screen or two lateral screens is/are placed immediately in front of the chip rack on a customer side of the gaming table.

51. A method for utilizing a gaming table with electronic memory microchip gaming chips, comprising:
providing a tabletop including a gaming chip storage area and at least one gaming chip testing area;
providing at least one test station including a communication unit adapted to exchange information with a memory of a gaming chip in said gaming chip testing area by an antenna device disposed at least one of on and in said tabletop, the communication unit being associated with a processing unit for processing information contained in said memory; and
providing at least one display device for displaying an output message obtained from the processing unit and based at least in part on information contained in said memory, said display device including a screen at least one of on and in said tabletop,
wherein the display device is physically separate from a casing of said test station and the gaming chip testing area and the screen of the display device are close together, beside said storage area and in reach and in view of an operator of the table.

52. The method of utilizing a gaming table according to claim 51, further comprising positioning the communication unit one of wholly or partially under the tabletop of the gaming table and said test station also incorporating in its casing the processing unit which has an output connected to the display device.

53. The method of utilizing a gaming table according to claim 52, further comprising positioning the gaming chip testing area beside a tip box.

54. The method of utilizing a gaming table according to claim 52, further comprising positioning two gaming chip testing areas laterally on either side of the chip rack and combining them with one of, a screen that is centrally located with respect to the chip rack, or with two lateral screens.

55. The method of utilizing a gaming table according to claim 54, further comprising placing one of the screen or two lateral screens immediately in front of the chip rack on a customer side of the gaming table.

56. The method of utilizing a gaming table according to claim 51, wherein on the tabletop of the gaming table, associating other areas for one of a) electronically reading or b) electronically reading and writing gaming chips with antennas having appropriate multiplex connections to the test station and via said test station to the screen of the display device.

57. A method of utilizing a gaming room surveillance equipment comprising providing at least one gaming table according to claim 51, comprising associating at least one display duplicator device with said display device of said gaming table and a second screen external to the gaming table can be viewed by a second gaming room operator.

58. The method of using a gaming room surveillance equipment according to claim 57, further comprising integrating the display duplicator device into a video surveillance system of a gaming room by one of a serial external interface, an IP network or an analogous network, with embedded display on screens of video monitors of one of a gaming room surveillance or a security staff.

59. The method of utilizing a gaming table according to claim 54, wherein said at least one of the screen or lateral screens is/are placed immediately in front of the chip rack on a customer side of the gaming table.
